(19) United States
(12) Patent Application Publication
(10) Pub. No.: US 2017/0370132 A1
(43) Pub. Date: Dec. 28, 2017

(54) TAILGATE LOCK ASSEMBLY

(71) Applicant: Huf North America Automotive Parts Manufacturing Corp., Milwaukee, WI (US)

(72) Inventors: Lynn D. Da Deppo, Bloomfield Hills, MI (US); Ehab Kamal, Novi, MI (US); Jeffery T. Root, Howell, MI (US)

(21) Appl. No.: 15/194,806

(22) Filed: Jun. 28, 2016

(51) Int. Cl. E05B 81/04; E05B 81/58; E05B 81/16; E05B 81/08; E05B 81/06; E05B 77/44; B60R 25/24; E05B 83/16; B60R 25/01

(52) U.S. Cl. CPC E05B 81/04; E05B 83/16; E05B 81/58; E05B 81/16; B60R 25/01; E05B 81/06; E05B 77/44; B60R 25/241; E05B 81/08

(57) ABSTRACT

A system for securing a tailgate to a vehicle body includes a housing secured to one of the tailgate and the vehicle body, the housing including a passageway. A projection is secured to the other of the tailgate and the vehicle body and is rotatably received by the housing in an attached state to rotatably attach the tailgate to the vehicle body and is separated from the housing in a detached state to permit removal of the tailgate from the vehicle body. The system also includes a locking mechanism operable in a locked state to block the passageway and prevent movement of the projection from the attached state to the detached state and an unlocked state opening the passageway to permit movement of the projection from the attached state to the detached state.

### FIELD

The present disclosure relates generally to a lock assembly and more particularly to a lock assembly for a vehicle having a tailgate or other removable closure.

### BACKGROUND

This section provides background information related to the present disclosure and is not necessarily prior art.

Many motor vehicles come equipped with tailgate assemblies. For example, pickup trucks often include a tailgate assembly that controls access to a bed portion of the pickup truck. In some implementations, tailgate assemblies are removably supported by the bed portion of the pickup truck. In this regard, the full functionality of the truck bed can be utilized by opening the tailgate assembly and/or removing the tailgate assembly from the pickup truck. The removability of tailgate assemblies can also make them vulnerable to car thieves. For this reason, locking systems have been developed to prevent inadvertent and other unwanted removal of the tailgate assembly from the vehicle. In this regard, some vehicles may utilize a handle locking system that prevents the tailgate assembly from opening and, thus, prevents the tailgate assembly from being removed from the vehicle. Other vehicles may utilize a projection locking system that prevents the tailgate assembly from being removed, regardless of whether the tailgate is open or closed.

Current handle locking systems are susceptible to being easily overridden and, as such, allow unauthorized individuals to remove the tailgate assembly from the vehicle. Current projection locking systems provide an added degree of security as compared to handle locking systems but do not allow authorized users to easily remove the tailgate assembly.

### SUMMARY

This section provides a general summary of the disclosure, and is not a comprehensive disclosure of its full scope or all of its features

A system for securing a tailgate to a vehicle body is provided and includes a housing secured to one of the tailgate and the vehicle body, the housing including a passageway. A projection is secured to the other of the tailgate and the vehicle body and is rotatably received by the housing in an attached state to rotatably attach the tailgate to the vehicle body and is separated from the housing in a detached state to permit removal of the tailgate from the vehicle body. The system also includes a locking mechanism operable in a locked state to block the passageway and prevent movement of the projection from the attached state to the detached state and an unlocked state opening the passageway to permit movement of the projection from the attached state to the detached state.

In some configurations, the system includes a controller in communication with the locking mechanism. The controller may move the locking mechanism between the locked state and the unlocked state. A driver may be in communication with the controller and may move the locking mechanism between the locked state and the unlocked state. The driver may be a solenoid or a reversing motor.

An authorization system may authenticate a valid user. The controller may prevent movement of the locking mechanism from the locked state to the unlocked state until the authorization system identifies a valid user. The authorization system may identify a valid user based on input from at least one of a key fob, a phone, or a switch.

In some implementations, the system includes an actuation member operable to transmit a wake-up signal to the authorization system. The controller may be operable in a dormant state until the actuation member transmits the wake-up signal to the authorization system. In some implementations, the controller may be operable to transition to a dormant state after a predetermined amount of time. The predetermined amount of time may be between 20 seconds and 120 seconds after transmission of the wake-up signal. In some implementations, the predetermined amount of time is measured by one of a timer and a capacitive charging device.

In some configurations, the locking mechanism includes a lock member blocking the passageway when the locking mechanism is in the locked state and spaced apart from at least a portion of the opening when the locking mechanism is in the unlocked state. The lock member may be slidably supported by the housing for movement along an arcuate path between the unlocked state and the locked state.

The projection may be rotatable about an axis when in the attached state to permit rotation of the tailgate relative to the vehicle body. The lock member may be rotatable about the axis between the locked state and the unlocked state.

According to another aspect, a method for securing a tailgate to a vehicle body is provided. The method may include securing a housing having a passageway to one of the tailgate and the vehicle body. The method may also include securing a projection to the other of the tailgate and the vehicle body. The projection may be rotatably received by the housing in an attached state to rotatably attach the tailgate to the vehicle body and may be separated from the housing in a detached state to permit removal of the tailgate from the vehicle body. The method may further include positioning a locking mechanism in one of a locked state blocking the passageway and preventing movement of the projection from the attached state to the detached state and an unlocked state opening the passageway and permitting movement of the projection from the attached state to the detached state.

In some implementations, the method includes providing a controller in communication with the locking mechanism. The controller may move the locking mechanism between the locked state and the unlocked state.

In some implementations, the method includes providing a driver in communication with the controller. The driver may move the locking mechanism between the locked state and the unlocked state. In some implementations, providing the driver may include providing a solenoid or a reversing motor.

In some implementations, activation of the controller may occur through communication (e.g., wired or wireless) between the locking device and an onboard transmitting device. For example, the activation of the controller may occur by activating the locking device after vehicle authentication protocols identify a valid user.

The method may additionally include providing an authorization system operable to authenticate a valid user. The method may include preventing movement of the locking mechanism from the locked state to the unlocked state via the controller until the authorization method identifies a valid user. In some implementations, identifying a valid user by the authorization system is based on input from at least one of a key fob, a phone, or a switch.

In some implementations, positioning the locking mechanism in the locked state includes blocking the passageway with a lock member. Positioning the locking mechanism in the unlocked state may include spacing the lock member from at least a portion of the opening.

In some implementations, the method includes slidably supporting the lock member by the housing for movement along an arcuate path between the unlocked state and the locked state. The method may include permitting rotation of the projection about an axis when in the attached state to permit rotation of the tailgate relative to the vehicle body. The lock member may be rotatable about the axis between the locked state and the unlocked state.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected configurations and not all possible implementations, and are not intended to limit the scope of the present disclosure.

FIG. 1A is a perspective view of a vehicle having a tailgate and a tailgate lock assembly in accordance with the principles of the present disclosure, the tailgate shown in a latched state;

FIG. 1B is a perspective view of the vehicle of FIG. 1A, the vehicle shown in an unlatched state;

FIG. 2 is an exploded view of the tailgate lock assembly of FIG. 1A, including a projection in accordance with the principles of the present disclosure;

FIG. 3A is a cross-sectional view of the tailgate lock assembly of FIG. 1A in a locked position;

FIG. 3B is a cross-sectional view of the tailgate lock assembly of FIG. 1A in an unlocked position;

FIG. 4A is a perspective view of a tailgate coupled to a vehicle using a tailgate lock assembly in accordance with the principles of the present disclosure; and

FIG. 4B is a perspective view of a tailgate removed from a vehicle using a tailgate lock assembly in accordance with the principles of the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

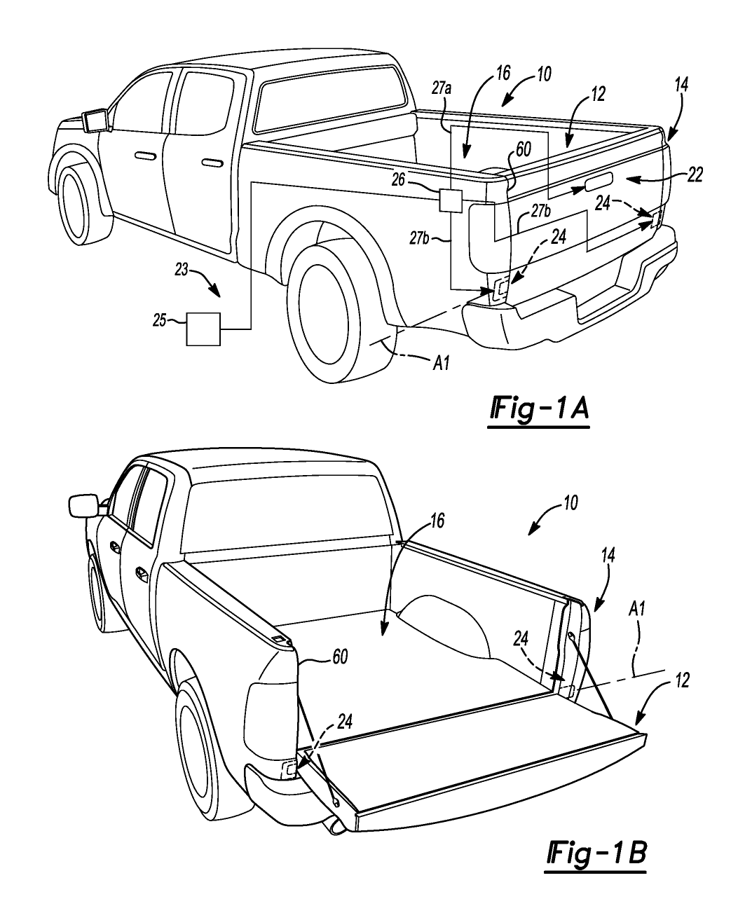

With reference to FIGS. 1A and 1B, a vehicle 10 is provided. The vehicle 10 may be any known variety of vehicle, such as a car, a truck, or a van, for example. The vehicle 10 may include a closure 12 and a body assembly 14. The closure 12 may be movably coupled to the body assembly 14 to allow a user to access, and/or to prevent the user from accessing, a portion of the vehicle 10. In some configurations, the closure 12 may include a tailgate assembly movably coupled to, and/or supported by, the body assembly 14. In this regard, the closure 12 may be referred to herein as the tailgate assembly 12. Accordingly, the tailgate assembly 12 may allow the user to access, and/or restrict the user from accessing, a bed portion 16 of the vehicle 10.

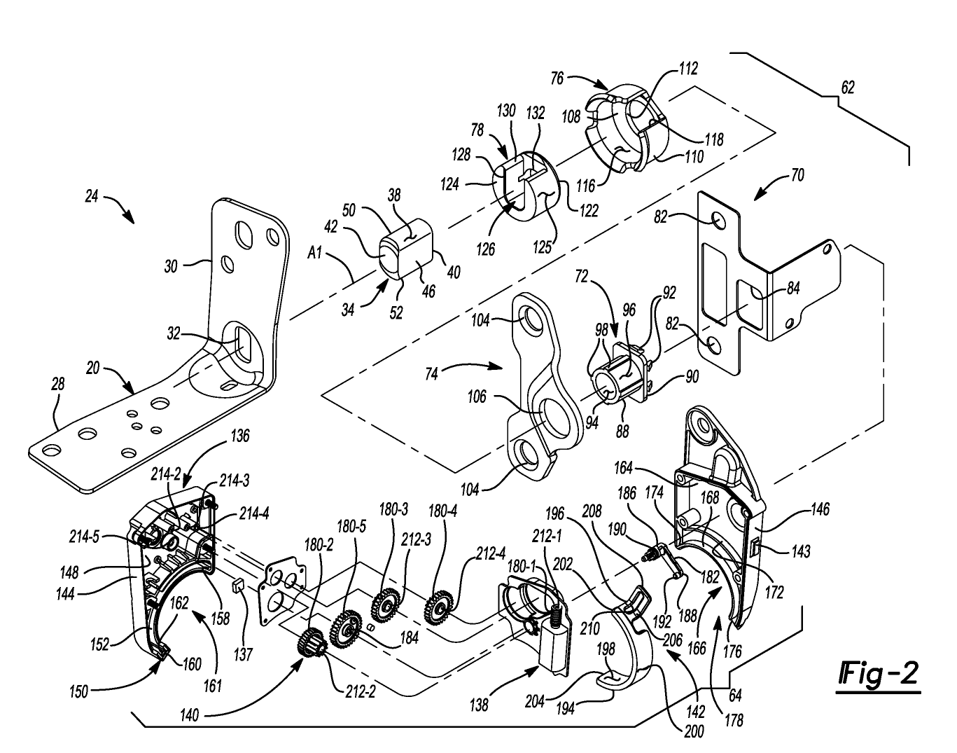

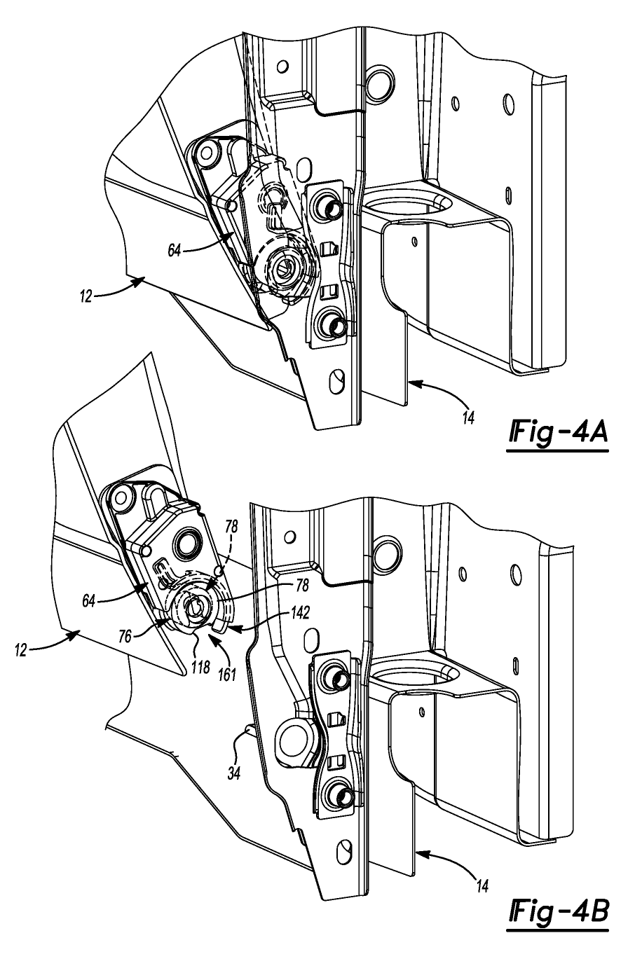

With reference to FIGS. 1A-2, the tailgate assembly 12 may include a pair of tailgate frame members 20, a latch assembly 22, and one or more lock assemblies 24. The tailgate assembly 12 may be coupled to the body assembly 14 for rotation about an axis A1. For example, the tailgate frame 20 may be rotatably supported by the lock assemblies 24 relative to the body assembly 14 such that the tailgate assembly 12 rotates between a closed position (FIG. 1A) and an open position (FIG. 1B). In this regard, opposed ends of the tailgate assembly 12 may each include a tailgate frame member 20 and a lock assembly 24. The latch assembly 22 may secure the tailgate assembly 12 relative to the body assembly 14 in order to prevent the tailgate assembly 12 from rotating about the axis A1 from the closed position to the open position. In this regard, as illustrated in FIG. 1A, an authorization and/or authentication system 23 may include an activation device 25 and a control module 26 in communication with the latch assembly 22 and/or the lock assemblies 24 to control a state (e.g., LOCK/UNLOCK) of the latch assembly 22 and the lock assemblies 24. For example, upon authentication of a valid user and/or a valid activation device 25, the control module 26 may transmit (e.g., wired or wireless communication) (i) a LOCK/UNLOCK signal 27a to the latch assembly 22 to prevent and/or allow a user to rotate the tailgate assembly 12 from the closed position (FIG. 1A) to the open position (FIG. 1B and FIG. 4A) and (ii) a LOCK/UNLOCK signal 27b to the lock assembly 24 to prevent and/or allow a user to proceed with unlocking the lock assemblies 24 and thereafter remove the tailgate assembly 12 from the vehicle 10 (FIG. 4B).

As illustrated in FIG. 2, the tailgate frame 20 may include a base 28 and an arm 30 extending from the base 28 such that the frame 20 defines a generally L-shaped construct. The arm 30 may include an aperture 32. In some configurations the aperture 32 may be disposed proximate the base 28 and may include an elongate shape to receive a portion of the lock assembly 24. In this regard, the axis A1 may extend through the aperture(s) 32.

A first portion of the lock assemblies 24 may be coupled to the tailgate frame 20 and a second portion of the lock assemblies 24 may be coupled to the body assembly 14 such that the axis A1 extends through the first and second portions of the lock assemblies 24. In particular, each lock assembly 24 may include a coupling member or projection 34 disposed within one of the apertures 32.

With reference to at least FIG. 2, the projection 34 may include an outer surface 38 extending from a proximal end 40 to a distal end 42. The outer surface 38 may include, and/or otherwise be defined at least in part by, a first lateral wall 46, a second lateral wall (not shown), an upper wall 50, and a lower wall 52. The first lateral wall 46 may be opposite the second lateral wall. The lower wall 52 may extend from the first lateral wall 46 to the second lateral wall. The upper wall 50 may be opposite the lower wall 52 and extend from the first lateral wall 46 to the second lateral wall.

The first lateral wall 46 and the second lateral wall may each include a generally planar construct. In some configurations, the first lateral wall 46 may be parallel to the second lateral wall. The upper and lower walls 50, 52 may include a generally convex construct such that the projection 34 defines a generally stadium-shaped configuration extending from the proximal end 40 to the distal end 42.

With reference to FIGS. 1-3B, the body assembly 14 may include a body 60, a coupling assembly 62, and a locking mechanism 64. The coupling assembly 62 may be coupled directly or indirectly to the body 60. In an assembled configuration, the projection 34 of the tailgate assembly 12 rotates relative to at least a portion of the coupling assembly 62, in order to allow the tailgate assembly 12 to rotate between the open position and the closed position. In this regard, while the tailgate assembly 12 and body assembly 14 are shown and described herein as including the locking mechanism 64 and the coupling assembly 62, respectively, it will be appreciated that the tailgate assembly 12 may include the coupling assembly 62 and/or the locking mechanism 64, and the body assembly 14 may include the lock assembly 24, within the scope of the present disclosure (e.g., FIGS. 4A and 4B).

The coupling assembly 62 may include a base plate 70, a support housing 72, a support plate 74, a housing or coupling member 76, and a carriage 78. The base plate 70 may be coupled to and/or supported by the body 60 and may include one or more mounting features 82 (e.g., apertures) and a housing-receiving feature 84 (e.g., aperture). The mounting features 82 may be sized and shaped to receive a fastener (not shown), such as a bolt, screw, or rivet, for example, to couple the base plate 70 to the body 60.

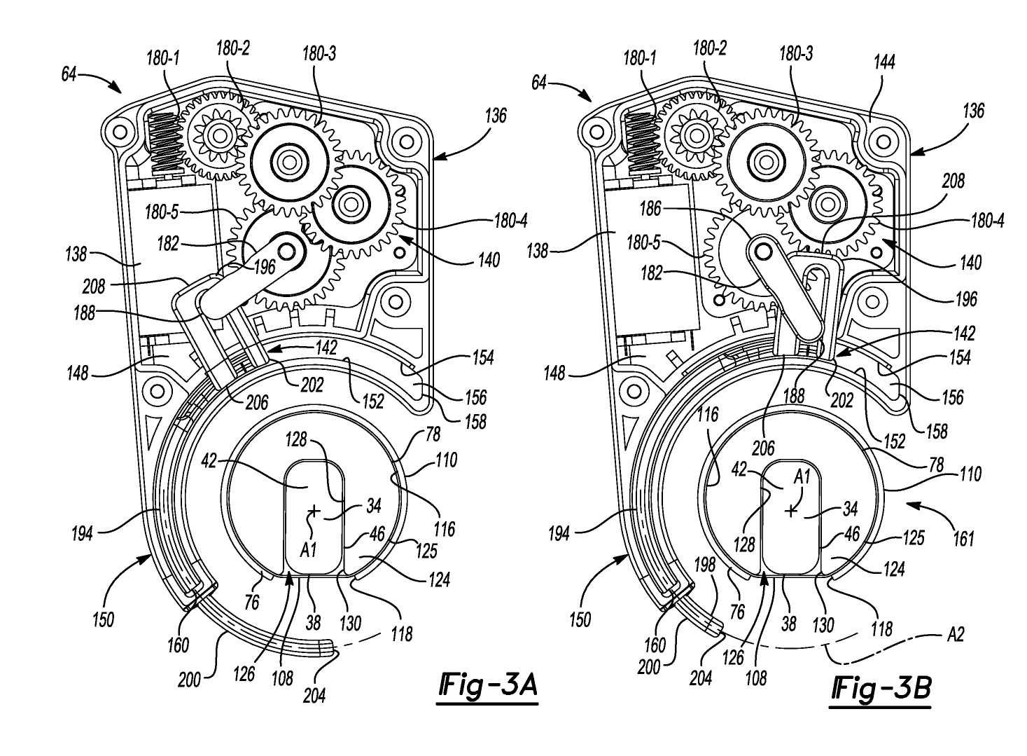

The support housing 72 may include a generally hollow cylinder 88, a mounting flange 90, and one or more mounting features 92 (e.g., clips). The cylinder 88 may include a generally cylindrical inner surface 94, a generally cylindrical outer surface 96, and one or more engagement features 98. The engagement feature(s) 98 (e.g., longitudinally extending ribs) may extend radially outward from the outer surface 96. The mounting flange 90 may extend radially outward from the outer surface 96. The one or more mounting features 92 (e.g., clips) may extend axially from the mounting flange 90, away from the cylinder 88. As illustrated in at least FIGS. 3A and 3B, in the assembled configuration, the mounting features 100 may be disposed within the housing-receiving feature 84 to secure the support housing 72 to the base plate 70.

The support plate 74 may include one or more mounting features 104 (e.g., apertures) and a support housing-receiving feature 106 (e.g., an aperture). In the assembled configuration, the mounting feature(s) 104 may be aligned with the mounting feature(s) 82 of the base plate 70, such that each fastener (not shown) extends through a mounting feature 104 of the support plate 74 and a mounting feature 82 of the base plate 70, respectively, in order to secure the support plate 74 to the base plate 70 and to secure the base plate 70 to the body 60. The housing-receiving feature 106 may receive the support housing 72 in order to secure the support housing 72 to the support plate 74. In this regard, the support housing 72 may be disposed within the housing-receiving feature 106 such that the engagement feature(s) 98 engage the support plate 74 in a press-fit configuration.

As illustrated in FIG. 2, the coupling member 76 may include a base portion 108 and a support portion 110. The base portion 108 may include a support-housing receiving feature 112 (e.g., an aperture). With reference to FIGS. 3A and 3B, in the assembled configuration, the support housing-receiving feature 112 may receive the support housing 72 in order to secure the support housing 72 to the coupling member 76. In this regard, the support housing 72 may be disposed within the support housing-receiving feature 112 such that the engagement feature(s) 98 engage the coupling member 76 in a press-fit configuration.

The support portion 110 may extend from the base portion 108 of the coupling member 76 and may define a generally hollow cylindrical construct. In this regard, the support portion 110 may include a cylindrical inner surface 116 and a slot 118. The inner surface 116 may surround the support-housing receiving feature 112. The slot 118 may extend through the support portion 110. As will be explained in more detail below, in the assembled configuration, the slot 118 may allow a user to assemble the tailgate assembly 12 to, and/or remove the tailgate assembly 12 from, the body assembly 14.

With reference to FIG. 2, the carriage 78 may include a proximal end 122, a distal end 124 opposite the proximal end 122, a peripheral surface 125, and a projection-receiving feature 126 (e.g., a slot). As illustrated in FIGS. 3A and 3B, in the assembled configuration, the carriage 78 may be disposed within the coupling member 76 for rotation about the axis A1. The peripheral surface 125 may extend from and between the proximal and distal ends 122, 124.

The projection-receiving feature 126 may be formed in one or more of the proximal end 122 and the peripheral surface 125. In this regard, the projection-receiving feature 126 may include an opening 128 formed in the distal end 124 of the carriage 78 and an opening 130 formed in the peripheral surface 125 of the carriage 78. In some configurations, the opening 128 and/or the opening 130 may be generally U-shaped such that the opening 128 communicates with and/or opens into the opening 130. The distal end 124 of the carriage 78 may include an aperture 132. The aperture 132 may open into and/or communicate with the projection-receiving feature 126, including the opening 128 formed in the proximal end 122 of the carriage 78. A size and shape of the projection-receiving feature 126 may correspond to a size and shape of the projection 34 such that the projection 34 can be received by the openings 128, 130 in order to assemble the projection 34 within, and remove the projection 34 from, the projection-receiving feature 126.

As illustrated in FIGS. 3A and 3B, in the assembled configuration, the carriage 78 may be disposed within the coupling member 76 such that the axis A1 extends through the proximal and distal ends 122, 124. In this regard, in some configurations, the axis A1 may extend through the aperture 132 and the opening 128. As will be explained in more detail below, the carriage 78, including the projection-receiving feature 126 and the aperture 132, may cooperate with the locking mechanism 64 to allow the tailgate assembly 12 to be removed from, and/or to prevent the tailgate 18 from being removed from, the body assembly 14.

With reference to FIG. 2, the locking mechanism 64 may include a housing 136, a power source 137, a driver 138, a drivetrain 140, a lock member 142, and an activation member 143. The housing 136 may include a first portion 144 and a second portion 146.

The first portion 144 of the housing 136 may include a cavity 148 and a track 150. In some implementations, the track 150 includes a first guide surface 152 and a second guide surface 154. The first guide surface 152 may extend in a direction substantially parallel to the second guide surface 154, such that the first and second guide surfaces 152, 154 define a channel 156 therebetween. In some configurations, the first and second guide surfaces 152, 154 may arcuately extend from a proximal end 158 of the track 150 to a distal end 160 of the track 150. In this regard, the first guide surface 152 may define a convex construct extending from the proximal end 158 to the distal end 160, and the second guide surface 154 may define a concave construct extending from the proximal end 158 to the distal end 160. The proximal and distal ends 158, 160 may define an opening 161 extending therebetween. The distal end 160 may include an aperture 162 in communication with the channel 156.

The second portion 146 of the housing 136 may include a cavity 164 and a track 166. In some implementations, the track 166 includes a first guide surface 168 and a second guide surface (not shown). The first guide surface 168 may extend in a direction substantially parallel to the second guide surface, such that the first guide surface 168 and the second guide surface define a channel 172 therebetween. In some configurations, the first guide surface 168 and the second guide surface may arcuately extend from a proximal end 174 of the track 166 to a distal end 176 of the track 166. In this regard, the first guide surface 168 may define a convex construct extending from the proximal end 174 to the distal end 176, and the second guide surface may define a concave construct extending from the proximal end 174 to the distal end 176. The proximal and distal ends 174, 176 may define an opening 178 extending therebetween.

The power source 137 may be disposed within the housing 136 to provide power to the driver 138. In this regard, the power source 137 may include a battery. It will be appreciated, however, that the locking mechanism 64 and the driver 138 may receive power from another source, such as the battery (not shown) of the vehicle 10. As will be explained in more detail below, the driver 138 may include any device and/or assembly that can selectively move the lock member 142 along the arcuate track 150 (e.g., about the axis A1). For example, the driver 138 may include a motor, a solenoid, a pneumatic actuator, or other device that can apply a force on the lock member 142 in a direction substantially tangential to the arcuate track 150.

The drivetrain 140 may include one or more drive members 180-1, 180-2, . . . 180-n and a coupling member 182. In some implementations, the drive members 180-1, 180-2, . . . 180-n include five gears intermeshed with one another, such that a rotation of a first drive member 180-1 causes a rotation of a fifth drive member 180-5. In this regard, the driver 138 may rotate the first drive member 180-1, which may, in turn, rotate the other drive members 180-n. At least one of the drive members 180-n may include a coupler 184. For example, as illustrated in FIG. 2, in some implementations, a fifth drive member 180-5 may include the coupler 184. The coupler 184 may be disposed at a center of the drive member 180-n. In this regard, the coupler 184 may be substantially aligned with an axis of rotation of the drive member 180-n. The coupler 184 may include one of a recess (e.g., an aperture or hub) and an axle. In some implementations, the coupler 184 includes an aperture 184 having an X-shape. While the drivetrain 140 is generally shown and described herein as including five drive members 180-1, 180-2, . . . 180-n, the drivetrain 140 may include more or less than five drive members 180-1, 180-2, . . . 180-n within the scope of the present disclosure.

The coupling member 182 may extend from a proximal end 186 to a distal end 188. The proximal end 186 may include a first coupler 190, and the distal end 188 may include a second coupler 192. The first coupler 190 may include one of a recess (e.g., an aperture or hub) and an axle. As illustrated in FIG. 2, in some implementations, the first coupler 190 includes a substantially X-shaped axle. The second coupler 192 may include one of a recess (e.g., an aperture or hub) and an axle. As illustrated in FIG. 2, in some implementations, the second coupler 192 includes an axle (e.g., a cylindrical pin).

The lock member 142 may include a lock portion 194 and a coupling portion 196. The lock portion 194 may include a first guide surface 198 and a second guide surface 200. The first guide surface 198 may extend in a direction substantially parallel to the second guide surface 200. In some configurations, the first and second guide surfaces 198, 200 may arcuately extend from a proximal end 202 of the lock portion 194 to a distal end 204 of the lock portion 194. In this regard, the first guide surface 198 may define a concave construct extending from the proximal end 202 to the distal end 204, and the second guide surface 200 may define a convex construct extending from the proximal end 202 to the distal end 204.

The coupling portion 196 may extend radially outward from the lock portion 194. In this regard, in some implementations, the coupling portion 196 includes a proximal end 206 supported by the lock portion 194, and a distal end 208 radially offset from the lock portion 194. The coupling portion 196 may include a coupler 210. The coupler 210 may include one of a recess (e.g., an aperture or hub) and an axle. As illustrated in FIG. 2, in some implementations, the coupler 210 includes an elongated aperture or slot.

In an assembled configuration, the first portion 144 of the housing 136 may be coupled to the second portion 146 of the housing 136, such that the cavity 148 and track 150 of the first portion 144 are aligned with the cavity 164 and track 166 of the second portion. The driver 138, drivetrain 140, and lock member 142 may be supported by at least one of the first portion 144 and second portion 146 of the housing 136. For example, the driver 138 and drivetrain 140 may be disposed within at least one of the cavity 148 of the first portion 144 and the cavity 164 of the second portion 146. Each of the drive members 180-1, 180-2, . . . 180-n may include a first rotation feature 212-1, 212-2, . . . 212-n (e.g., a hub or an axle), and at least one of the first and second portions 144, 146 of the housing 136 may include a second rotation feature 214-1, 214-2, . . . 214-n (e.g., a hub or an axle) rotatably coupled to a corresponding one of the first rotation features 212-1, 212-2, . . . 212-n. As illustrated in FIG. 2, the first drive member 180-1 may be coupled to the driver for rotation therewith. The coupling member 182 may be supported by one of the drive members 180-1, 180-2, . . . 180-n and the lock member 142. For example, in some implementations, the coupling member 182 is supported by the fifth drive member 180-5 for rotation therewith. In this regard, the first coupler 190 of the coupling member 182 may be coupled to the coupler 184 of the fifth drive member 180-5. The second coupler 192 may be coupled to the coupler 210 of the lock member 142. For example, the second coupler 192 (e.g., a pin, as previously described) may be translatably and rotatably disposed within the coupler 210 (e.g., an aperture, as previously described).

The lock member 142 may be supported by at least one of the track 150 of the first portion 144 and the track 166 of the second portion 146. For example, the lock member 142 may be disposed within the channel 156 of the track 150 and/or the channel 172 of the track 166. In some implementations, the first guide surface 198 of the lock member 142 may be adjacent to, and/or slidably engage, the first guide surface 152 of the track 150 and/or the first guide surface 168 of the track 166, and the second guide surface 200 of the lock member 142 may be adjacent to, and/or slidably engage, the second guide surface 154 of the track 150 and/or the second guide surface of the track 166. In this regard, as will be explained in more detail below, the lock member 142 may be disposed within, and/or extend through, the aperture 162 of the first portion 144 of the housing 136 such that during operation of the locking mechanism 64, the lock member 142 translates and/or rotates relative to the housing 136 between a locked state (FIG. 3A) and an unlocked state (FIG. 3B). In the locked state, the lock member 142 may be disposed within the openings 161 and/or 178 defined by the first portion 144 and/or second portion 146, respectively, of the housing 136. In this regard, the lock member 142 may move along an arcuate path or axis A2 between the locked state and the unlocked state. As illustrated in FIGS. 3A and 3B, the axis A2 may be defined by at least one of the lock member 142 and/or the tracks 150, 166, and may be concentrically disposed about the axis A1.

The activation member 143 may include a button, switch, or other suitable device for communicating with the driver 138. As illustrated in FIG. 2, the activation member 138 may be disposed on an outer surface of the second portion 146 of the housing 136. As will be explained in more detail below, the activation member 143 may include a button that, when pressed, transmits an activation or wake-up signal to a portion of the authentication system 23. For example, the activation member 143 may transmit a wake-up signal to the controller 26.

With continued reference to FIGS. 3A-3B, operation of the tailgate assembly 12 will now be described. In a first state, the tailgate assembly 12 may be coupled to the body assembly 14 in a closed position (FIG. 1A) or an open position (FIG. 1B), and the locking mechanism 64 may be supported by, and/or coupled to, one of the tailgate assembly 12 and the body assembly 14, such that the openings 161 and/or 178 are aligned with the slot 118 of the coupling member 76 and the opening 130 of the carriage 78. The lock member 142 may extend from the aperture 162 to cover, or otherwise block, at least a portion of the slot 118, the opening 130, and/or the openings 161, 178 to secure the projection 34 within the projection-receiving feature 126 of the carriage 78 (FIG. 3A). Accordingly, the lock member 142 may prevent movement of the tailgate assembly 12 relative to the body assembly 14 in a direction generally perpendicular to the axis A1, while still allowing rotational movement of the tailgate assembly 12 relative to the body assembly 14 about the axis A1.

In order to unlock the tailgate assembly 12 relative to the body assembly 14 (e.g., in order to remove the tailgate assembly 12 from the body assembly 14), the user may wake-up the authentication system 23 (e.g., the controller 26) and/or the locking mechanism 64 (e.g., the driver 138) by pressing the activation member 143. For example, the activation member 143 may transmit a wake-up signal to the controller 26 through a wired or wireless communication protocol, such that the controller 26 transitions from a dormant or sleep state to an active or awake state. Within a predetermined period of time T1, the user may use the authentication system 23 to actuate the driver 138. The predetermined period of time T1 may be between 20 seconds and 120 seconds, as determined or otherwise measured by a timer (not shown) and/or a capacitive charger (not shown) disposed within the vehicle 10. In some implementations, the predetermined period of T1 may be equal to 60 seconds. In this regard, the user may actuate the driver 138 using the activation device 25 (e.g., a mechanical activation device, such as a key, for example, or an electronic activation device, such as a key FOB, a phone, or a switch, for example). In one configuration, a user may utilize a key FOB to transmit a signal to the control module 26. Upon authenticating the activation device 25, the control module 26 may transmit an UNLOCK signal 27b to the lock assembly 24 and actuate the driver 138 in order to allow a user to remove the tailgate assembly 12 from the vehicle 10. If the user does not use the authentication system 23 to actuate the driver 138 within the predetermined period of time T1, the authentication system 23 (e.g., the controller 26) and/or the locking mechanism 64 (e.g., the driver 138) may transition to the dormant state.

Actuating the driver 138 causes the first drive member 180-1 and various other drive members 180-2, 180-3, 180-4, 180-5 to rotate relative to the housing 136. As the drive members 180-1, 180-2, 180-3, 180-4, 180-5 rotate, the coupling member 182 likewise rotates, thereby causing the second coupler 192 to translate and rotate within and relative to the coupler 210 from the distal end 208 of the coupler 210 to the proximal end 206 of the coupler 210. Translation and/or rotation of the second coupler 192 within the coupler 210 causes the lock member 142 to move along the axis A2 relative to the housing 136 and into an unlocked position (FIG. 3B) such that the slot 118 of the coupling member 76 and the opening 130 of the carriage 78 are not covered by the lock member 142. In this regard, in the unlocked position, the lock member 142 may be disposed within the channels 156, 176 of the housing 136.

Once the slot 118 of the coupling member 76 and the opening 130 of the carriage 78 are not covered and/or blocked by the lock member 142, the user may move the projection 34 and, thus, the tailgate assembly 12 in a direction generally perpendicular to the axis A1. For example, with reference to FIG. 4B, the user may lift and remove the tailgate assembly 12 relative to the body assembly 14 such that the projection 34 (i) exits the projection-receiving feature 126 of the carriage 78 through the opening 130 and (ii) exits the coupling member 76 through the slot 118. If the user does not remove the tailgate assembly 12 from the body assembly 14 within a predetermined amount of time T2 (e.g., more than the predetermined amount of time T1 and less than eight hours), the driver 138 may move the lock member 142 from the unlocked position (FIG. 3B) to the locked position (FIG. 3A), in the manner described above.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A system for securing a tailgate to a vehicle body, the system comprising:
a housing secured to one of the tailgate and the vehicle body and including passageway;
a projection secured to the other of the tailgate and the vehicle body and rotatably received by the housing in an attached state to rotatably attach the tailgate to the vehicle body and separated from the housing in a detached state to permit removal of the tailgate from the vehicle body; and
a locking mechanism operable in a locked state to block the passageway and prevent movement of the projection from the attached state to the detached state and an unlocked state opening the passageway to permit movement of the projection from the attached state to the detached state.

2. The system of claim 1, further comprising a controller in communication with the locking mechanism and operable to move the locking mechanism between the locked state and the unlocked state.

3. The system of claim 2, further comprising a driver in communication with the controller, the driver operable to move the locking mechanism between the locked state and the unlocked state.

4. The system of claim 3, wherein the driver is a solenoid or a reversing motor.

5. The system of claim 2, further comprising an authorization system operable to authenticate a valid user.

6. The system of claim 5, wherein the controller prevents movement of the locking mechanism from the locked state to the unlocked state until the authorization system identifies a valid user.

7. The system of claim 5, further comprising an actuation member operable to transmit a wake-up signal to the authorization system.

8. The system of claim 7, wherein the controller is operable in a dormant state until the actuation member transmits the wake-up signal to the authorization system.

9. The system of claim 7, wherein the controller is operable to transition to a dormant state after a predetermined amount of time.

10. The system of claim 9, wherein the predetermined amount of time is between 20 seconds and 120 seconds after transmission of the wake-up signal.

11. The system of claim 9, wherein the predetermined amount of time is measured by one of a timer and a capacitive charging device.

12. The system of claim 5, wherein the authorization system is operable to identify a valid user based on input from at least one of a key fob, a phone, or a switch.

13. The system of claim 1, wherein the locking mechanism includes a lock member blocking the passageway when the locking mechanism is in the locked state and spaced apart from at least a portion of the opening when the locking mechanism is in the unlocked state.

14. The system of claim 13, wherein the lock member is slidably supported by the housing for movement along an arcuate path between the unlocked state and the locked state.

15. The system of claim 13, wherein the projection is rotatable about an axis when in the attached state to permit rotation of the tailgate relative to the vehicle body, the lock member being rotatable about the axis between the locked state and the unlocked state.

16. A method for securing a tailgate to a vehicle body, the method comprising:
securing a housing having a passageway to one of the tailgate and the vehicle body;
securing a projection to the other of the tailgate and the vehicle body, the projection rotatably received by the housing in an attached state to rotatably attach the tailgate to the vehicle body and separated from the housing in a detached state to permit removal of the tailgate from the vehicle body; and
positioning a locking mechanism in one of a locked state blocking the passageway and preventing movement of the projection from the attached state to the detached state and an unlocked state opening the passageway and permitting movement of the projection from the attached state to the detached state.

17. The method of claim 16, further comprising providing a controller in communication with the locking mechanism, the controller and operable to move the locking mechanism between the locked state and the unlocked state.

18. The method of claim 17, further comprising providing a driver in communication with the controller, the driver operable to move the locking mechanism between the locked state and the unlocked state.

19. The method of claim 18, wherein providing the driver includes providing a solenoid or a reversing motor.

20. The method of claim 17, further comprising providing an authorization system operable to authenticate a valid user.

21. The method of claim 20, further comprising preventing movement of the locking mechanism from the locked state to the unlocked state via the controller until the authorization method identifies a valid user.

22. The method of claim 20, further comprising identifying a valid user by the authorization system based on input from at least one of a key fob, a phone, or a switch.

23. The method of claim 16, wherein positioning the locking mechanism in the locked state includes blocking the passageway with a lock member and positioning the locking mechanism in the unlocked state includes spacing the lock member from at least a portion of the opening.

24. The method of claim 23, further comprising slidably supporting the lock member by the housing for movement along an arcuate path between the unlocked state and the locked state.

25. The method of claim 23, further comprising permitting rotation of the projection about an axis when in the attached state to permit rotation of the tailgate relative to the vehicle body, the lock member being rotatable about the axis between the locked state and the unlocked state.
